(19) United States
(12) Patent Application Publication
(10) Pub. No.: US 2022/0106063 A1
(43) Pub. Date: Apr. 7, 2022

(54) SATELLITE DEPLOYER METHOD, SYSTEM, AND APPARATUS

(71) Applicant: OMNITEQ, LLC, Houston, TX (US)

(72) Inventor: Michael David Johnson, Houston, TX (US)

(21) Appl. No.: 17/493,553

(22) Filed: Oct. 4, 2021

Related U.S. Application Data
(60) Provisional application No. 63/087,253, filed on Oct. 4, 2020.

(51) Int. Cl. B64G 1/64

(52) U.S. Cl. CPC B64G 1/641; B64G 2001/643; B64G 1/645

(57) ABSTRACT

The disclosure relates to an improved satellite deployer system and method utilizing a novel geometric configuration employing a draft geometry between a satellite and a deployer that prevents jamming of a satellite during deployment while simultaneously reducing satellite deployment tipoff rates. The satellite deployer system includes a receptacle having the general shape of an extruded cylinder or polygon with draft. The satellite deployer system includes a satellite shaped to conform with the inside of the receptacle. The satellite deployer system includes a releasable mechanism to hold the satellite in the receptacle. The satellite deployer system includes an ejector mechanism that pushes or pulls the satellite out of the receptacle. The satellite is deployed from the launch vehicle by the ejector mechanism after the releasable mechanism is released.

### CROSS-REFERENCE TO RELATED APPLICATIONS

The present application claims priority from U.S. Provisional Patent Application Ser. No. 63/087,253, filed on Oct. 4, 2020, which is incorporated herein by its entirety and referenced thereto.

### FIELD OF THE DISCLOSURE

This disclosure relates generally to a satellite deployer system and method utilizing a novel geometric configuration employing a draft geometry between a satellite and a deployer that prevents jamming of a satellite during deployment while simultaneously reducing satellite deployment tipoff rates.

### BACKGROUND OF THE DISCLOSURE

For the purposes of interpreting the disclosure made herein, the terms “CubeSat deployer”, “satellite deployer”, “satellite deployer system”, or derivations thereof are used interchangeably and should be considered synonymous. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Commercial development outside the earth's atmosphere, i.e., outer space, presents physical and logistics challenges and difficulties. The hazards and costs associated with outer space commerce are of a different nature from those within the earth's atmosphere. Because of these challenges and difficulties, satellites have been, and will continue to be a primary means for the clear majority of extra-planetary operations. Satellites have been used to explore space, gather and relay data, perform experiments, and do any other number of tasks.

Picosatellites, including CubeSats, provide a means for minimizing the financial barrier to space entry. The components used to build CubeSats are usually relatively inexpensive, off-the-shelf electronics. The small size of these CubeSats and other picosatellites coupled with their uniform dimensions and inexpensive components make these satellites an attractive means of accessing space at a relatively small cost.

Miniaturized satellites can simplify problems commonly associated with mass production, although few satellites of any size, other than “communications constellations” (where dozens of satellites are used to cover the globe), have been mass-produced in practice. One reason for miniaturizing satellites is to reduce the cost associated with transporting them into space. Heavier satellites require more energy to transport them into orbit or open space, thereby requiring larger rockets with greater fuel requirements, which results in higher costs. In contrast, smaller and lighter satellites require less energy and less volume (requiring smaller and cheaper launch vehicles) and may be launched in multiples, or in other words, deployed in groups and at the same time. These small satellites, such as CubeSats and other picosatellites, can also be launched in a “piggyback” manner, using excess capacity available on already loaded launch vehicles.

The high cost of transporting mass from the surface of a stellar body into an orbit around a celestial body, or open space, has especially limited the development of outer space commercial activity. This high cost per unit mass has made minimizing the mass of the objects being sent into space particularly important. To achieve their purpose, CubeSats must be transported out of the atmosphere and released into space (whether that is into an orbit around a celestial body or into open space). Satellite deployers are used to store and protect satellites during their transportation into space. These satellite deployers protect the payloads stored inside of them from damage caused by the inherent stresses resulting from launching such payloads into space. The satellite deployer must also safely and efficiently deploy their satellite payloads into the correct trajectory once the system has reached space.

California Polytechnic State University (“Cal Poly”) initiated the CubeSat concept in 1999, to enable users to perform space science and exploration at lower costs. A basic CubeSat (“1U”) is a 10 cm cube (one liter in volume) having a mass of approximately 1.33 kg. Other common sizes are available, including a “2U” that is 20 cm×10 cm×10 cm, and a “3U” that is 30 cm×10 cm×10 cm. Other sizes, such as a “6U” (30 cm×10 cm×20 cm), “12U” (30 cm×20 cm×20 cm), and “27U” (30 cm×30 cm×30 cm), have also been proposed, the dimensions cited herein are ‘nominal.’ The standardized specification of CubeSats also allows for the deployment means of these satellites to be standardized as well. The standardization among both payloads and deployers enables quick exchanges of payloads without the need of customized payload-deployer interfaces. It also allows for easily interchanging parts across similarly dimensioned satellites.

Associated with the minimization of mass is the minimization of volume. This is important in the field of space transportation since there is a finite amount of usable storage volume inside of space vehicles. This minimization of mass and volume is important not only for satellites, but for the systems used to store, transport and deploy the satellites.

To deploy a CubeSat in space, a dispensing device is used to ‘push’ the CubeSat away from the delivery spacecraft. This dispensing device is also used to transport the CubeSat and to secure it to the delivery spacecraft. Current dispensing devices include the “P-Pod” (Poly's Pico-satellite Orbital Deployer), designed by Cal Poly, and the ISIPOD deployer, designed by ISIS (Innovative Solutions In Space). The P-Pod deployer accommodates a “3U” CubeSat, or, equivalently, three “1U” CubeSats, or, one “1U” CubeSat and one “2U” CubeSat“. The ISIPOD is also available in a variety of sizes.

Satellite deployers may be designed as metal storage containers into which satellites are placed. These container-type satellite deployers usually provide a door at one end, through which payloads may be loaded and unloaded. After loading, the deployer system's door is secured, and the deployer system is then mounted onto a launch vehicle which is responsible for transporting the deployer system, including any satellites or other space payloads stored therein, into space.

CubeSats typically utilize a rail system to hold the CubeSat in the deployer during launch and the rail system is then used as a guide during ejection from the deployer. The traditional CubeSat deployer (e.g. CalPoly or ISIS deployer) uses a four-rail system with a rail at each corner of the deployer (relative to the longitudinal axis of the deployer) to restrain the CubeSat which is required to have a matching rail set that slides along the deployer rails during ejection. Many difficulties are encountered with this system as it requires rather precise flatness of the rails and will not allow twisting of the satellite body in any manner. This system also suffers from rail friction problems especially in a vacuum environment which may require special coatings to prevent vacuum welding. The system also suffers from transmission of launch and vibration loads directly into the satellite body, thus defeating any structural advantage to the satellite the deployer may provide during launch and requires that the satellite launch loads are concentrated onto the four rails of the deployer/satellite. Many vibration isolation schemes have been proposed to limit the transmission of vibration into the satellite but these schemes require additional vibration isolators that add additional weight, further defeating the mass advantages of the CubeSat format.

An alternative CubeSat deployer format is the “tab” or flange system of Holemans in U.S. Pat. No. 9,415,883. In this system each CubeSat includes a pair (i.e. two) of opposing flanges on a lower portion of the satellite that ride in a channel formed by the deployer's guide rails and restraining flanges. During travel and launch, the satellite flanges are held against the restraining flanges, rigidly fixing the satellite to the dispenser until the satellite is deployed. Many difficulties are encountered with this system as it requires very precise flatness of the flanges and will not allow twisting of the satellite body in any manner. This system also suffers from rail/flange friction problems especially in a vacuum environment which may require special coatings to prevent vacuum welding. This system also utilizes a special clamping mechanism between the satellite deployer and the satellite flanges that is particularly troublesome as it intentionally transmits launch and vibration loads directly into the satellite body, thus defeating any structural advantage to the satellite the deployer may provide during launch and requires that the satellite launch loads are concentrated onto the two tabs (i.e. double that of the standard CubeSat four-rail deployer) of the deployer/satellite. Many vibration isolation schemes have been proposed to limit the transmission of vibration into the satellite but these schemes require additional vibration isolators that add further weight, thus defeating the mass advantages of the CubeSat format.

It is well known in prior art that satellite deployers utilize various types of coiled springs to provide separation force between a deployer and a satellite being deployed. These springs are called deployment springs. Springs are well known to store relatively limited amounts of energy.

The P-POD and similar deployers are designed to carry standard format CubeSats which are stored in the deployer's rectangular outer aluminum or composite box with an electrically released door mechanism. After an electrical signal is sent from a launch vehicle, the front door hold down mechanism is opened and the CubeSat(s) are pushed out by a deployment spring exerting force on a pusher plate which pushes the back of the end CubeSat. The CubeSat(s) slide along guide rails that typically have an aspect ratio (i.e. satellite length to width) that is longer than the width of the satellite. The deployer spring force eventually ejects the CubeSats(s) into orbit with a separation velocity of a few meters per second.

Other satellite deployer systems are known in the art as separation systems (e.g. Holemans U.S. Pat. No. 7,861,976 also known the Planetary Systems Corporation Lightband and the classic Marmon Clamp Meyer U.S. Pat. No. 3,420,470). These systems generally do not have a containment structure around the satellite and just attach a “fly-away” ring to the base of the satellite. As such, the satellite structure must be designed to transmit all loads through the base of the satellite in a cantilever fashion. This requires a heavy structure at the base of the satellite. Separation systems also require complex mechanisms with very precise machining requirements (e.g. extreme flatness) between mating surfaces since all the holding force of the separation system is concentrated across a small area. In addition, these systems impose a large mechanical shock upon separation of the launch vehicle and satellite due to the rapid release of retention system preload required for securing (due to launch and vibration loads) the satellite side of the separation system to the launch vehicle side of the separation system.

Long duration human spacecraft systems (e.g. the International Space Station) require trash disposal systems. Flexible trash bags loaded with trash and deployed from an airlock have been proposed but require complex guide rail systems and are prone to jamming due to the indeterminate shape of the loaded trash bag (i.e. large protruding trash objects).

The disclosed subject matter helps to avoid these and other problems in a new and novel way.

### SUMMARY OF THE DISCLOSURE

The disclosure relates to an improved satellite deployer system and method utilizing a novel geometric configuration employing a draft geometry between a satellite and a deployer that prevents jamming of a satellite during deployment while simultaneously reducing satellite deployment tipoff rates.

According to the teachings of the present disclosure, there is here provided a satellite deployer system that utilizes 1. A receptacle located on the launch vehicle side of the apparatus having the general shape of an extruded cylinder or polygon with angled sides (i.e. draft) where the smaller diameter of the extruded cylinder or polygon is located on the launch vehicle side, 2. A satellite whose shape generally conforms to the inside of the receptacle, 3. A releasable restraint system that holds satellite in place until the desired deployment time and 4. An ejector mechanism that pushes satellite out of receptacle in a general straight line motion.

The main advantages of using the inventive satellite deployer system is that it provides a launch load support system that off loads the satellite structure while providing jam-free, low shock, and low tipoff ejection of the satellite.

The concept of draft in molds used to mass produce objects (e.g. plastic injection molds) is well known in the art and is utilized to ensure rapid and jam-free ejection of molded parts from molds automatically. For example, disposable plastic cups are formed in the general shape of a truncated cone or, in other words, an extruded cylinder with a specific draft angle.

The draft angle is not particularly specific as the principle of a separating pair of nested cones only requires a tiny amount of movement along the cylinder's axial axis to ensure complete separation of all surfaces. Draft separation relies on the geometric principle of nested triangles. If any two triangles contact each other on their hypotenuse sides and are moved apart from each other with a motion parallel to either opposing side, the entire hypotenuse sides are separated. This is in contradistinction to nested cylinders where the contacting sides remain in contact until they are completely separated from each other.

A first embodiment of the invention utilizes a receptacle located on the launch vehicle side of the apparatus having the general shape of a shallow extruded cylinder with draft (i.e. a cone) where the smaller diameter of the extruded cylinder has an interface flange (outward or inward facing) that is fastened (i.e. bolted, riveted, welded, bonded, etc.) to the launch vehicle side and, on the opposing larger diameter side of the cone, another outward facing interface flange is provided that can join to a flyaway ring on the satellite side. On the satellite side, a flyaway ring is provided whose shape generally conforms to the inside of the receptacle whose larger diameter side has an outward facing flange that is fastened (i.e. bolted, riveted, welded, bonded, etc.) to the satellite side. This same outward facing flange mates to the receptacle outward facing flange and both are joined by releasable mechanisms that permit separation of the receptacle and flyaway ring when desired. It is important to note that the conic shape of the receptacle and flyaway ring with the added flanges produces an extremely high strength to weight ratio structure which is highly desirable for spacecraft launch purposes. Finally, after release of the releasable mechanisms, an ejector mechanism is provided that pushes the satellite out of the receptacle by applying the ejection force vector to the satellite through the center of gravity of the satellite thereby minimizing or eliminating tip-off moments. Any convenient ejector mechanism may be utilized to induce separation, for example, a spring or multiple springs, hydraulic or pneumatic ejectors, reaction motors (e.g. cold gas rockets, solid/liquid rocket motors, etc.). It is not intended to limit the invention to any particular ejector mechanism.

A second embodiment of the invention utilizes a receptacle located on the launch vehicle side of the apparatus having the general shape of a deep extruded cylinder or polygon with draft where the smaller diameter of the extruded cylinder/polygon has an interface flange (outward or inward facing) that is fastened (i.e. bolted, riveted, welded, bonded, etc.) to the launch vehicle side and, on the opposing larger diameter side of the extruded cylinder/polygon, another outward facing interface flange is provided that can join to a flange on the satellite. The satellite is shaped to generally conform to the inside of the deep receptacle and is generally completely encased by the receptacle. The larger diameter side of the satellite has an outward facing flange or tabs that are fastened (i.e. bolted, riveted, welded, bonded, etc.) to or are inherently built into the satellite side body. This same outward facing flange on the satellite side mates to the receptacle outward facing flange and both are joined by releasable mechanisms that permit separation of the receptacle and satellite when desired. It is important to note that the conic shape of the receptacle with the added flanges produces an extremely high strength to weight ratio structure which is highly desirable for spacecraft launch purposes. An alternate method of containment and release may be to utilize a door at the larger diameter end of the receptacle where a hinge and opposing releasable mechanism hold the door in place for launch and, with the release of the releasable mechanism, permits the door to open and release the satellite contained inside the receptacle. Finally, after release of the releasable mechanisms (or door), an ejector mechanism is provided that pushes the satellite out of the receptacle by applying the ejection force vector to the satellite through the center of gravity of the satellite thereby minimizing or eliminating tip-off moments. In this embodiment the ejector mechanism may apply the ejection force behind the satellite center of gravity or (which is more desirable) in front of the satellite center of gravity thus providing an inherently stable application of ejection force (similar to a tractor-like application of force) and adds to the ability of the system to provide a low tip-off rate ejection of the satellite. Any convenient ejector mechanism may be utilized to induce separation, for example, a spring or multiple springs, hydraulic or pneumatic ejectors, reaction motors (e.g. cold gas rockets, solid/liquid rocket motors, etc.), permanent magnets, electromagnetic, etc. Any parallel or straight-line motion mechanisms may be used (e.g. scissor jack mechanisms) in conjunction with a motive force to provide straight line motion of the motive force. It is not intended to limit the invention to any particular ejector mechanism.

A peculiar and extremely useful property of this embodiment is that since the receptacle completely encases the satellite, the receptacle is capable of handling the majority of the launch loads of the satellite and receptacle thus, when the satellite is deployed from the receptacle, the additional structural weight generally required to handle launch loads is left behind on the launch vehicle. This is particularly useful for orbital upper stage applications where it is desirable to minimize the amount of unused structure mass in the structure that is propelled onward after achieving initial orbital velocity (and microgravity) above a planetary body. For example, an electrically propelled upper stage must survive launch loads but does not require a strong structure after achieving low earth orbit since the force applied by the electric thruster is extremely low. The second embodiment of the inventive device permits this mode of transportation where essentially all the launch loads are taken up by the receptacle and the ejected upper stage may utilize an extremely lightweight, gossamer-like structure.

The addition of adapters to the second embodiment adapts a standard, rectangular format satellite (e.g. a rail type CubeSat) to be deployed from the receptacle formed as deep extruded four-sided polygon with draft. As an example, four adapter structures are formed that, on the inner surface, interface with one rail of a CubeSat and, on the outer surface, conform to the draft surface of the receptacle. Upon installation of the CubeSat into the receptacle, the four adapters follow the draft of the receptacle and present a uniform clamping force to the four rails of the CubeSat thereby restraining the motion of the CubeSat to the center of the receptacle. The CubeSat and the four adapters are then constrained in place by a forward door hinged to the receptacle. A releasable mechanism secures the door in place until the desired deployment. When deployment of the satellite occurs, the releasable mechanism opens the receptacle door and an ejector mechanism of any convenient choice (e.g. spring, pneumatic, etc.) pushes the CubeSat out of the receptacle while simultaneously urging the adapters outward. Urging the adapters outward removes the clamping force imposed upon the four rails and releases the CubeSat. The adapters should be somehow restrained by the receptacle to prevent any unnecessary debris from being released from the receptacle during satellite deployment.

The second embodiment is also particularly suited for transporting and deploying inflatable spacecraft or soft goods to an orbital location. In the past, most inflatable structures or soft good items have been simply bundled and strapped to a flat plate. This method presents a variety of problems, most notably the lack of securing the load's center of gravity in a specific location. Such variability of center of gravity causes significant problems with launch vehicle and spacecraft guidance systems that can end in the loss of a launch vehicle or result in a collision. The inventive device overcomes these problems by completely encasing the soft structure inside the receptacle during launch and, when deployment is desired, ejected from the receptacle. It should be noted that the satellite inside the receptacle can be completely incapable of handling any launch loads whatsoever as all launch loads can be accommodated by the receptacle structure. This enables an entirely new and novel method of satellite construction. The draft angle provided on the side of the receptacle also accommodates any changes in the geometry of the soft goods during deployment which could potentially cause jamming or hang up of the soft goods in the receptacle during deployment.

A further benefit of the second embodiment of the inventive device is for the disposal of trash in a manned space station situation. Trash may be loosely defined as the undesirable remains of activities that need to be removed from the area of activities. As such, it is highly desirable to spend as little time planning and performing trash removal as well as minimizing orbital debris (i.e. keeping the trash together as a large, trackable space object) which poses a significant problem in the spacecraft environment. The second embodiment of the inventive device may be configured to utilize a trash bag that generally conforms to a receptacle installed in an airlock. The receptacle is in the shape of a deep extruded cylinder or polygon with draft where the smaller diameter of the extruded cylinder/polygon is positioned on the inner side of an airlock and, the opposing larger diameter side of the extruded cylinder/polygon is pointed in the deployment direction from the airlock. The receptacle can be mounted in the airlock via any convenient manner such as flanges or attaching the sides of the receptacle to the inner walls of the airlock. The trash bag can be filled with trash from either the small diameter end of the receptacle or the large diameter end of the receptacle. Once the bag is sealed it is ready for deployment from the receptacle. An ejection mechanism (e.g. a pneumatic bag, spring system, etc.) is placed between the filled trash bag and the receptacle on the small diameter end of the receptacle. It should be noted that the airlock wall could form a wall (or end cap) of the receptacle and the ejection mechanism could be mounted on the airlock wall. The large diameter end of the trash bag can utilize some form of releasable restraint (e.g. straps held down with releasable mechanism) between the larger diameter, forward end of the receptacle and the trash bag. It should be noted that the releasable restraint could also be connected between the trash bag and the airlock wall.

Upon completion of filling the trash bag, placing the ejection mechanism and restraining the trash bag, the airlock may be depressurized, the airlock opened to space and the large diameter end of the receptacle be pointed in the desired ejection direction to space. The releasable restraint is released, the ejection mechanism is operated, and the trash bag is deployed into space.

A significant advantage to this trash disposal system is that any shaped object may be placed into the trash bag during the loading process without regard or concern of jamming of the ejection of the trash bag during the eventual ejection process due to the receptacle's wall draft. Any object, rigid or flexible (e.g. bags of liquids) may be accommodated so long as it can fit within the confines of the receptacle. The trash bag can be filled to any capacity so long as the entire trash bag fits within the confines of the receptacle. The trash bag need not be rigid in any way. This eliminates any planning concerns on the part of the crew for trash disposal and trash may be added to the bag until it is full at which point it may be sealed and ejected from the spacecraft.

It should be noted that a convenient, low shock releasable mechanism that could be utilized with the inventive device is detailed in the Applicant's co-pending Provisional Patent Application 63/087,250 dated Oct. 4, 2020.

Descriptions of certain illustrative aspects are described herein in connection with the figures. These aspects are indicative of various non-limiting ways in which the disclosed subject matter may be utilized, all of which are intended to be within the scope of the disclosed subject matter.

Other advantages, emerging properties, and features will become apparent from the following detailed disclosure when considered in conjunction with the associated figures that are also within the scope of the disclosure.

### BRIEF DESCRIPTION OF THE DRAWINGS

The present subject matter will now be described in detail with reference to the drawings, which are provided as illustrative examples of the subject matter to enable those skilled in the art to practice the subject matter. Notably, the figures and examples are not meant to limit the scope of the present subject matter to a single embodiment, but other embodiments are possible by way of interchange of some or all of the described or illustrated elements and, further, wherein:

FIG. 1 illustrates the novel principles of the inventive device;

FIG. 2 illustrates a first embodiment of the inventive device;

FIG. 3 illustrates a second embodiment of the inventive device;

FIG. 4 illustrates the second embodiment of the inventive device utilizing a door for a restraint mechanism;

FIG. 5 illustrates the second embodiment of the inventive device utilizing adapters for CubeSat satellites; and

FIG. 6 illustrates the second embodiment of the inventive device configured for transportation and deployment of soft articles.

### DETAILED DESCRIPTION OF ILLUSTRATIVE EMBODIMENTS

The detailed description set forth below in connection with the appended drawings is intended as a description of exemplary embodiments in which the presently disclosed process can be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed method and system. However, it will be apparent to those skilled in the art that the presently disclosed process may be practiced without these specific details. In some instances, well-known structures and devices are shown in block diagram form to avoid obscuring the concepts of the presently disclosed method and system.

In the present specification, an embodiment showing a singular component should not be considered limiting. Rather, the subject matter preferably encompasses other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present subject matter encompasses present and future known equivalents to the known components referred to herein by way of illustration.

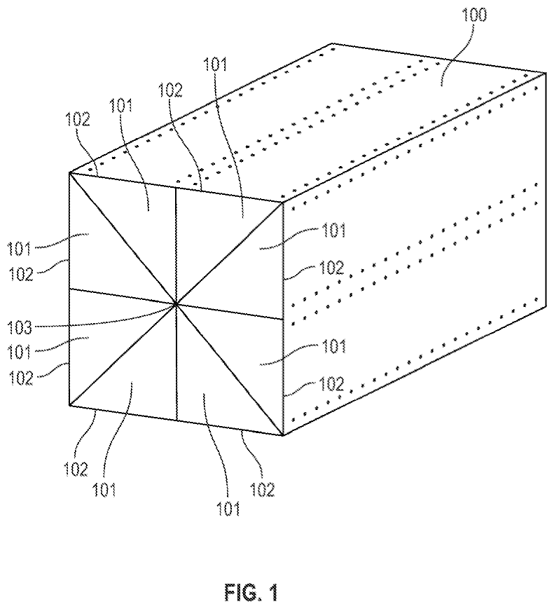

The figures herein provided, in conjunction with the written description here, clearly provide enablement of all claimed aspects of the disclosed subject matter. Accordingly, in FIG. 1 the concept of draft 100 (e.g. as used in molds to mass produce objects) is well known in the art and is utilized to ensure rapid and jam-free ejection of molded parts 101 from molds 102 automatically. For example, disposable plastic cups are formed in the general shape of a truncated cone or, in other words, an extruded cylinder 101 with a specific draft angle 100.

The draft angle 100 is not particularly specific as the principle of a separating pair of nested cones 101/102 only requires a tiny amount of movement 103 along the cylinder's axial axis 104 to ensure complete separation of all surfaces. Draft separation relies on the geometric principle of nested triangles. If any two triangles (contained in parts 101/102) contact each other on their hypotenuse sides and are moved apart from each other with a motion 103 parallel to either opposing side, the entire hypotenuse sides are separated. This is in contradistinction to nested cylinders 105/106 where the contacting sides remain in contact until they are completely separated from each other.

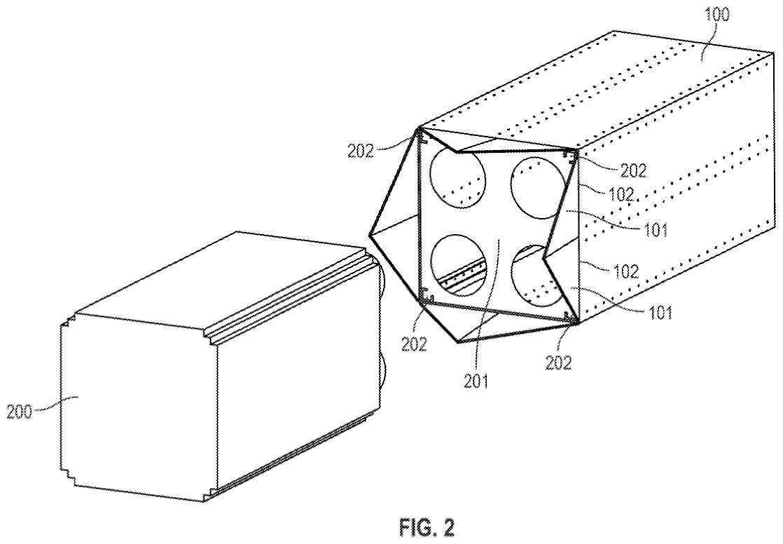

In FIG. 2 the first embodiment of the invention utilizes receptacle 200 located on the launch vehicle side of the apparatus having the general shape of a shallow extruded cylinder with draft (i.e. a cone) where the smaller diameter of extruded cylinder 200 has an interface flange 201 (outward or inward facing) that is fastened (i.e. bolted, riveted, welded, bonded, etc.) to the launch vehicle side and, on the opposing larger diameter side of the cone, another outward facing interface flange 201 is provided that can join to a flyaway ring 202 on satellite 203 side. On the satellite side, a flyaway ring 202 is provided whose shape generally conforms to the inside of receptacle 200 whose larger diameter side has an outward facing flange 201 that is fastened (i.e. bolted, riveted, welded, bonded, etc.) to satellite 203 side. This same outward facing flange 201 mates to receptacle 200 outward facing flange 201 and both are joined by releasable mechanisms 204 that permit separation of receptacle 200 and flyaway ring 202 when desired. It is important to note that the conic shape of receptacle 200 and flyaway ring 202 with the added flanges 201 produces an extremely high strength to weight ratio structure which is highly desirable for spacecraft launch purposes. Finally, after release of the releasable mechanisms 204, ejector mechanism 205 is provided that pushes satellite 203 out of receptacle 200 by applying the ejection force vector 206 to satellite 203 through the center of gravity 207 of satellite 203 thereby minimizing or eliminating tip-off moments. Any convenient ejector mechanism 205 may be utilized to induce separation, for example, a spring or multiple springs, hydraulic or pneumatic ejectors, reaction motors (e.g. cold gas rockets, solid/liquid rocket motors, etc.). It is not intended to limit the invention to any particular ejector mechanism 205.

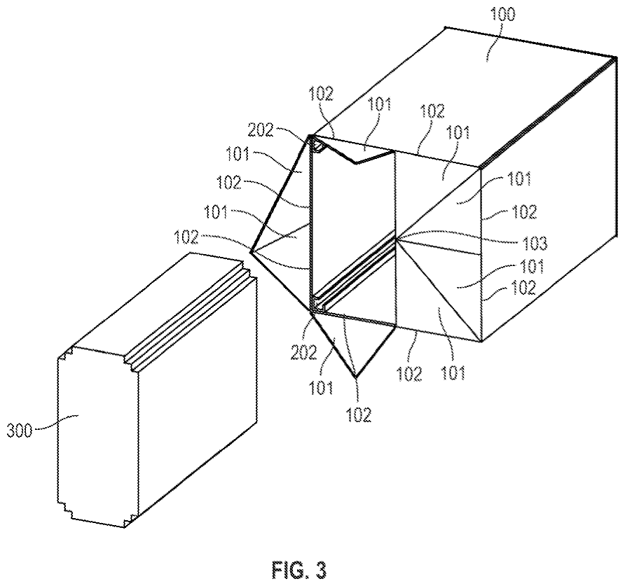

A second embodiment of the invention illustrated in FIG. 3 utilizes receptacle 200 located on the launch vehicle side of the apparatus having the general shape of a deep extruded cylinder or (in this example, an eight-sided) polygon with draft where the smaller diameter of the extruded cylinder/polygon has an interface flange 201 (outward or inward facing) that is fastened (i.e. bolted, riveted, welded, bonded, etc.) to the launch vehicle side and, on the opposing larger diameter side of the extruded cylinder/polygon, another outward facing interface flange 201 is provided that can join to a flange 201 on satellite 203. Satellite 203 is shaped to generally conform to the inside of the deep receptacle 200 and is generally completely encased by receptacle 200. The larger diameter side of satellite 203 has an outward facing flange 201 or tabs 201 that are fastened (i.e. bolted, riveted, welded, bonded, etc.) to or are inherently built into satellite 203 side body. This same outward facing flange on satellite 203 side mates to receptacle 200 outward facing flange 201 and both are joined by releasable mechanisms 204 that permit separation of receptacle 200 and satellite 203 when desired. It is important to note that the conic shape of receptacle 200 with the added flanges 201 produces an extremely high strength to weight ratio structure which is highly desirable for spacecraft launch purposes. Finally, after release of the releasable mechanisms 204, ejector mechanism 205 is provided that pushes satellite 203 out of receptacle 200 by applying the ejection force vector 206 to satellite 203 (in this example) ahead of the center of gravity 207 of satellite 203 thereby minimizing or eliminating tip-off moments. Any convenient ejector mechanism 205 may be utilized to induce separation, for example, a spring or multiple springs, hydraulic or pneumatic ejectors, reaction motors (e.g. cold gas rockets, solid/liquid rocket motors, etc.). It is not intended to limit the invention to any particular ejector mechanism 205.

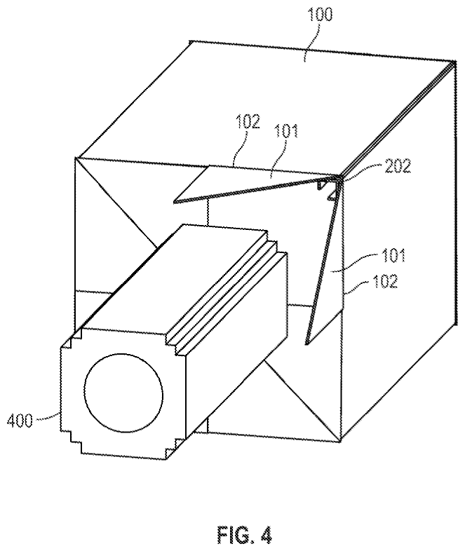

In FIG. 4 an alternate method of containment and release may be to utilize a door 400 at the larger diameter end of receptacle 200 where a hinge 401 and opposing releasable mechanism 204 hold the door 400 in place for launch and, with the release of the releasable mechanism 204, permits the door 400 to open and release satellite 203 contained inside receptacle 200. Finally, after release of the releasable mechanisms 204 (or door 400), an ejector mechanism 205 is provided that pushes satellite 203 out of receptacle 200 by applying the ejection force vector to satellite 203 through the center of gravity of satellite 203 thereby minimizing or eliminating tip-off moments. In this embodiment the ejector mechanism 205 may apply the ejection force behind satellite 203 center of gravity or (which is more desirable) in front of satellite 203 center of gravity thus providing an inherently stable application of ejection force (similar to a tractor-like application of force) and adds to the ability of the system to provide a low tip-off rate ejection of satellite 203. Any convenient ejector mechanism 205 may be utilized to induce separation, for example, a spring or multiple springs, hydraulic or pneumatic ejectors, reaction motors (e.g. cold gas rockets, solid/liquid rocket motors, etc.), permanent magnets, electromagnetic, etc. Any parallel or straight-line motion mechanisms may be used (e.g. scissor jack mechanisms or pneumatic bag as illustrated, etc.) in conjunction with a motive force to provide straight line motion of the motive force. It is not intended to limit the invention to any particular ejector mechanism 205.

A peculiar and extremely useful property of this embodiment is that since receptacle 200 completely encases satellite 203, receptacle 200 is capable of handling the majority of the launch loads of satellite 203 and receptacle 200 thus, when satellite 203 is deployed from receptacle 200, the additional structural weight generally required to handle launch loads is left behind on the launch vehicle. This is particularly useful for orbital upper stage applications where it is desirable to minimize the amount of unused structure mass in the structure that is propelled onward from the launch vehicle after achieving initial orbital velocity (and microgravity) above a planetary body. For example, an electrically propelled upper stage must survive launch loads but does not require a strong structure after achieving low earth orbit since the force applied by the electric thruster is extremely low. The second embodiment of the inventive device permits this mode of transportation where essentially all the launch loads are taken up by receptacle 200 and the ejected upper stage 203 may utilize an extremely lightweight, gossamer-like structure.

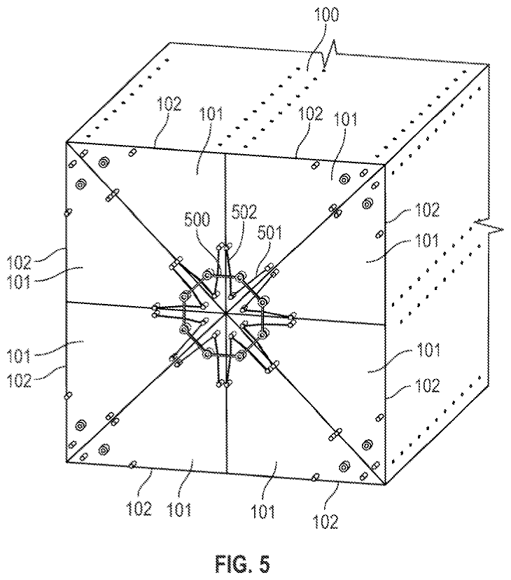

In FIG. 5 the addition of adapters 500 to the second embodiment adapts a standard, rectangular format satellite 203 (e.g. a rail type CubeSat) to be deployed from receptacle 200 formed as deep extruded four-sided polygon with draft. As an example, four adapter structures 500 are formed that, on the inner surface, each interface with one rail 501 of a CubeSat 203 and, on the outer surface, each conform to the draft surface of receptacle 200. Upon installation of CubeSat 203 into receptacle 200, the four adapters 500 follow the draft of receptacle 200 and present a uniform clamping force to the four rails 501 of CubeSat 203 thereby restraining the motion of CubeSat 203 to the center of receptacle 200. CubeSat 203 and the four adapters 500 are then constrained in place by a forward door 400 hinged 401 to receptacle 200. A releasable mechanism 204 secures the door 400 in place until the desired deployment. When deployment of satellite 203 occurs, the releasable mechanism 204 opens receptacle 200 door 400 and an ejector mechanism 205 of any convenient choice (e.g. spring, pneumatic, etc.) pushes CubeSat 203 out of receptacle 200 while simultaneously urging adapters 500 outward. Urging adapters 500 outward removes the clamping force imposed upon four rails 501 and releases CubeSat 203. The adapters should be restrained to receptacle 200 by any convenient means known in the art (e.g. t-pin on adapter 500 and slot in receptacle 200) to prevent any unnecessary debris from being released from receptacle 200 during satellite 203 deployment.

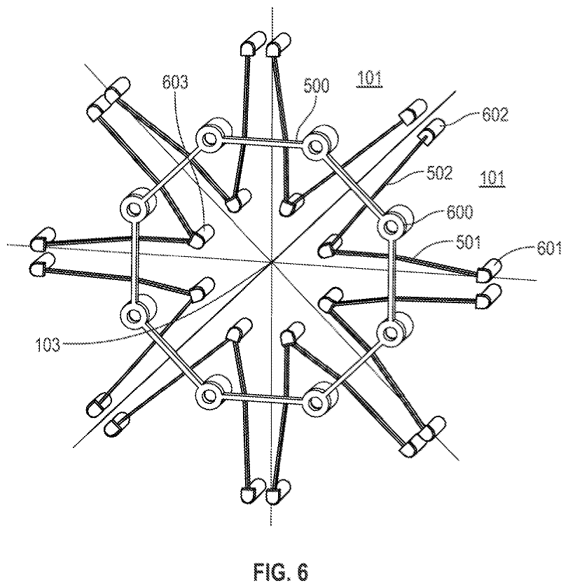

In FIG. 6 the second embodiment is also particularly suited for transporting and deploying inflatable spacecraft or soft goods to an orbital location. In the past, most inflatable structures or soft good items have been simply bundled and strapped to a flat plate. This method presents a variety of problems, most notably the lack of securing the load's center of gravity in a specific location. Such variability of center of gravity causes significant problems with launch vehicle and spacecraft guidance systems that can end in the loss of control resulting in the loss of a launch vehicle or result in a collision. The inventive device overcomes these problems by completely encasing the soft structure (a.k.a. satellite) 203 inside receptacle 200 during launch and, when deployment is desired, ejected from receptacle 200. It should be noted that satellite 203 inside receptacle 200 can be completely incapable of handling any launch loads whatsoever as all launch loads can be accommodated by receptacle 200 structure. This enables an entirely new and novel method of satellite 203 construction. The draft angle 100 provided on the side of receptacle 200 also accommodates any changes in the geometry of the soft goods 203 during deployment which could potentially cause jamming or hang up of soft goods 203 in receptacle 200 during deployment.

FIG. 6 also illustrates a further benefit of the second embodiment of the inventive device for the disposal of trash 600 in a manned space station situation. Trash 600 may be loosely defined as the undesirable remains of activities that need to be removed from the area of activities. As such, it is highly desirable to spend as little time planning and performing trash 600 removal as well as minimizing orbital debris (i.e. keeping trash 600 together as a large, trackable space object) which poses a significant problem in the spacecraft environment. The second embodiment of the inventive device may be configured to utilize a trash bag 601 that generally conforms to receptacle 200 installed in an airlock 602 (e.g. Johnson, et. al. U.S. Pat. No. 10,569,911 as used in FIG. 6). Receptacle 200 is in the shape of a deep extruded cylinder or polygon with draft where the smaller diameter of the extruded cylinder/polygon is positioned on the inner side of an airlock 602 and, the opposing larger diameter side of the extruded cylinder/polygon receptacle 200 is pointed in the deployment direction from the airlock 602. Receptacle 200 can be mounted in the airlock 602 via any convenient manner such as flanges or attaching the sides of receptacle 200 to the inner walls of the airlock 602. The trash bag 601 can be filled with trash from either the small diameter end of receptacle 200 or the large diameter end of receptacle 200. Once the bag 601 is sealed, it is ready for deployment from receptacle 200. An ejection mechanism 205 (e.g. a pneumatic bag, spring system, etc.) is placed between the filled trash bag 601 and receptacle 200 on the small diameter end of receptacle 200. It should be noted that the airlock 602 wall could form a wall (or end cap) of receptacle 200 and the ejection mechanism 205 could be mounted on the airlock 602 wall. The large diameter end of the trash bag 601 can utilize some form of releasable restraint (e.g. straps held down with releasable mechanism 204) between the larger diameter, forward end of receptacle 200 and the trash bag 601. It should be noted that the releasable restraint 204 could also be connected between the trash bag 601 and the airlock 602 wall.

Upon completion of filling the trash bag 601, placing the ejection mechanism 205 and restraining the trash bag 601, the airlock 602 may be depressurized, the airlock 602 opened to space and the large diameter end of receptacle 200 be pointed in the desired ejection direction to space. The releasable restraint 204 is released, the ejection mechanism 205 is operated, and the trash bag 601 is deployed into space.

A significant advantage to this trash disposal system is that any shaped object may be placed into the trash bag 601 during the loading process without regard or concern of jamming of the ejection of the trash bag 601 during the eventual ejection process due to receptacle 200's wall draft. Any object, rigid or flexible (e.g. bags of liquids) may be accommodated so long as it can fit within the confines of receptacle 200. The trash bag 601 can be filled to any capacity so long as the entire trash bag 601 fits within the confines of receptacle 200. The trash bag 601 need not be rigid in any way. This eliminates any planning concerns on the part of the crew for trash disposal and trash may be added to the bag until it is full at which point it may be sealed and ejected from the spacecraft.

It should be noted that a convenient, low shock releasable mechanism 204 that could be utilized with the inventive device is detailed in the Applicant's co-pending Provisional Patent Application 63/087,250 dated Oct. 4, 2020.

In summary, here has been shown a satellite deployer system that utilizes 1. A receptacle 200 located on the launch vehicle side of the apparatus having the general shape of an extruded cylinder or polygon with angled sides (i.e. draft) where the smaller diameter of the extruded cylinder or polygon is located on the launch vehicle side, 2. A satellite 203 whose shape generally conforms to the inside of the receptacle, 3. A releasable restraint system that holds satellite 203 in place until the desired deployment time and 4. An ejector mechanism 205 that pushes satellite 203 out of receptacle 200 in a general straight line motion.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The detailed description set forth here, in connection with the appended drawings, is intended as a description of exemplary embodiments in which the presently disclosed subject matter may be practiced. The term “exemplary” used throughout this description means “serving as an example, instance, or illustration,” and should not necessarily be construed as preferred or advantageous over other embodiments.

This detailed description of illustrative embodiments includes specific details for providing a thorough understanding of the presently disclosed subject matter. However, it will be apparent to those skilled in the art that the presently disclosed subject matter may be practiced without these specific details. In some instances, well-known structures and devices are shown in block diagram form in order to avoid obscuring the concepts of the presently disclosed method and system.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. The claimed subject matter set forth in the claims is not intended to be limited to the embodiments shown herein, but is to be accorded the widest scope consistent with the principles and novel features disclosed herein. It is contemplated that additional embodiments are within the spirit and true scope of the disclosed subject matter.

What is claimed is:

1. A satellite deployer system, comprising:
a receptacle with draft, wherein the smaller diameter of said receptacle locates on the side facing a launch vehicle;
a satellite shaped to conform with the inside of said receptacle;
a releasable mechanism to hold said satellite in said receptacle; and
an ejector mechanism that pushes or pulls said satellite out of said receptacle,
wherein said satellite is deployed from said launch vehicle by said ejector mechanism after said releasable mechanism is released.

2. The satellite deployer system of claim 1, wherein said receptacle has a shape of an extruded cylinder or polygon.

3. The satellite deployer system of claim 1, wherein said receptacle has an interface flange for receiving said satellite.

4. The satellite deployer system of claim 3, wherein said satellite has an outward facing interface flange connecting said interface flange of said receptacle.

5. The satellite deployer system of claim 4, wherein said releasable mechanism joins said interface flange and said outward facing interface.

6. The satellite deployer system of claim 3, wherein said outward facing interface flange comprises a tab.

7. The satellite deployer system of claim 1, wherein said satellite has a flyaway ring, wherein flyaway ring conforms to the inner shape of said receptacle.

8. The satellite deployer system of claim 1, wherein said ejector mechanism comprises one of a spring, a hydraulic or pneumatic ejector, a reaction motor, and a magnet.

9. The satellite deployer system of claim 1, wherein said receptacle comprises a door for enclosing said satellite within said receptacle, wherein said releasable mechanism secures said door in place until deployment of said door.

10. The satellite deployer system of claim 9, wherein said door operates by a hinge.

11. The satellite deployer system of claim 1, wherein said receptacle comprises adapters with rails.

12. The satellite deployer system of claim 11, wherein said satellite comprises rail-like structures, wherein said rails in said receptacle receives said satellite at said rail-like structures.

13. The satellite deployer system of claim 1, wherein said satellite comprises a trash bag.

14. The satellite deployer system of claim 1, wherein said satellite provides a material made of soft structure.

15. A method of proving a satellite deployer system, said method comprising the steps of:
providing a receptacle with draft, the smaller diameter of said receptacle locating on the side facing a launch vehicle;
providing a satellite shaped to conform with the inside of said receptacle;
housing said satellite in said receptacle;
providing a releasable mechanism to hold said satellite in said receptacle;
providing an ejector mechanism; and
ejecting said satellite from said receptacle via said ejection mechanism.

16. The method of claim 15, further comprising providing an interface flange at said receptacle.

17. The method of claim 16, further comprising providing an outward facing interface flange at said satellite for connecting said interface flange of said receptacle.

18. The method of claim 17, further comprising joining said interface flange and said outward facing interface by said releasable mechanism.

19. The method of claim 18, further comprising providing a door at said receptacle for enclosing said satellite within said receptacle, said door secured by said releasable mechanism.

20. The method of claim 18, further comprising:
providing adapters with rails in said receptacle;
providing rail-like structures at said satellite; and
receiving said rail-like structures at said rails for connecting said satellite to said receptacle.
